(19) United States
(12) Patent Application Publication
(10) Pub. No.: US 2003/0135497 A1
(43) Pub. Date: Jul. 17, 2003

(54) Recording medium on which file search program is recorded and file search apparatus

(76) Inventor: Takatoshi Mochizuki, Kobe-Shi (JP)

Correspondence Address: BURNS, DOANE, SWECKER & MATHIS, L.L.P., P.O. Box 1404, Alexandria, VA, 22313-1404, US

(21) Appl. No.: 10/342,202

(22) Filed: Jan. 15, 2003

(30) Foreign Application Priority Data
Jan. 15, 2002 (JP) 2002-6310

(51) Int. Cl. G06F 7/00

(52) U.S. Cl. 707/3

(57) ABSTRACT

A primary search session is executed using primary search keywords set in step S101, and secondary search keywords to be used for a synonym-based search are extracted from among the keywords assigned to the files extracted via the primary search. The secondary search keywords may include all keywords assigned to the files extracted in the primary search, keywords commonly assigned to multiple files, or the top several keywords selected in accordance with the number of files to which they are assigned. A synonym-based search is executed using these secondary search keywords (S105), and the results thereof are displayed (S107). The primary search results and the synonym-based search results may be displayed without being distinguished from each other or in a manner that distinguishes them from each other.

This application is based on application No. 2002-6310 filed in Japan, the content of which is hereby incorporated by reference.

### BACKGROUND OF THE INVENTION

1. Field of the Invention

The present invention relates to a file search program and to a recording medium on which such program is recorded, and more particularly to a file search program that is capable of performing a wide-range search and to a recording medium on which such program is recorded.

2. Description of the Related Art

When a user searches for desired files among various files stored in a server or the like, a search method is available by which a wide-range search is carried out directly using keywords input by the user and a synonym-based search is further performed using synonyms of the keywords.

For performing this synonym-based search, secondary search keywords are generally extracted from a thesaurus that is created in advance, in addition to the original keywords. For example, Japanese Laid-Open Patent Application H07-141397 discloses a search method for a document search apparatus in which synonyms are searched for based on the index words (keywords) input by the user, keywords to be used for secondary search are found from a thesaurus created in advance and based on prescribed information regarding the synonyms thus found, and a secondary search is carries out.

However, a search method of the conventional art such as that disclosed in Japanese Laid-Open Patent Application H07-141397 described above entails the problems that a thesaurus must be created in advance and maintained.

### SUMMARY OF THE INVENTION

According to one aspect of the present invention, a computer-readable recording medium on which is stored a file search program that causes the computer to execute a file search in a file search apparatus, said program causing the computer to execute the steps of: assigning multiple keywords to each data file; selecting at least one keyword as a first keyword from among the keywords assigned; searching for one or more data files using the selected first keyword or keywords; selecting a second keyword that is assigned to the data files extracted via said search and is not said first keyword or keywords; and searching for one or more data files using the selected second keywords.

According to another aspect of the present invention, a computer-readable recording medium on which is stored a file search program that causes the computer to execute a file search in a file search apparatus storing multiple image data files, said program causing the computer to execute the steps of: selecting from among multiple keywords at least one keyword as the first keyword to be used to search among the image data files to which the multiple keywords are assigned; searching for at least one image data file among the image data files using the selected first keyword or keywords; selecting second keywords from among keywords assigned to the image data files extracted in the previous search, and the second keywords are different from the first keyword; and searching for at least one image data file among the image data files using the selected second keywords to the extract image data files.

According to another aspect of the present invention, a file search apparatus comprises a storage device in which are stored multiple image data files, each having multiple keywords assigned thereto; a first selector that selects as first keyword at least one keyword from among the multiple keywords; a first searcher that performs a search among the image data files using the selected first keyword; a second selector that selects second keywords from among the keywords assigned to the image data files extracted via said search, and the second keywords are different from the first keyword; and a second searcher that performs a search among the image data files using the selected second keywords and extracts image data files.

### BRIEF DESCRIPTION OF THE DRAWINGS

These and other objects and features of this invention will become clear from the following description, taken in conjunction with the preferred embodiments with reference to the accompanied drawings in which:

FIG. 1 is a drawing showing a specific example of the construction of a filing system pertaining to an embodiment of the present invention;

FIG. 2 is a block diagram showing the construction of the filing apparatus 2 shown in FIG. 1;

FIG. 3 is a flow chart showing the main routine of the program executed by the filing apparatus 2;

FIG. 4 is a flow chart showing the search subroutine of step S5 in FIG. 3;

FIG. 5 is a flow chart showing the search subroutine of step S105 in FIG. 4;

FIG. 6 is a flow chart showing a first subroutine for the secondary search keyword extraction of step S201 in FIG. 5;

FIG. 7 is a flow chart showing a second subroutine for the secondary search keyword extraction of step S201 in FIG. 5;

FIG. 8 is a flow chart showing a third subroutine for the secondary search keyword extraction of step S201 in FIG. 5;

FIG. 9 is a flow chart showing a first subroutine for the synonym-based search result display of step S107 in FIG. 4;

FIG. 10 is a flow chart showing a second subroutine for the synonym-based search result display of step S107 in FIG. 4;

FIG. 11 is a drawing showing a specific example of files stored in the RAM 205 of the filing apparatus 2;

FIG. 12 is a drawing showing a specific example of the display screen that displays the search results from the primary search session and the search results from the secondary search session while distinguishing them from each other using different font sizes;

FIG. 13 is a drawing showing a specific example of the display screen that displays the search results from the primary search session and the search results from the secondary search session while distinguishing them from each other using different colors;

FIG. 14 is a drawing showing a specific example of the display screen that displays the search results from the primary search session and the search results from the secondary search session while distinguishing them from each other using different degrees of darkness; and

FIG. 15 is a drawing showing a specific example of the display screen that displays the search results from the primary search session and the search results from the secondary search session while distinguishing them from each other using different display locations.

### DETAILED DESCRIPTION OF THE PREFERRED EMBODIMENTS

Embodiments of the present invention are described below with reference to the drawings. In the description below, common components and constituent elements share the same number, as well as the same name and functions. Therefore, once described, such common components and constituent elements will not be described again.

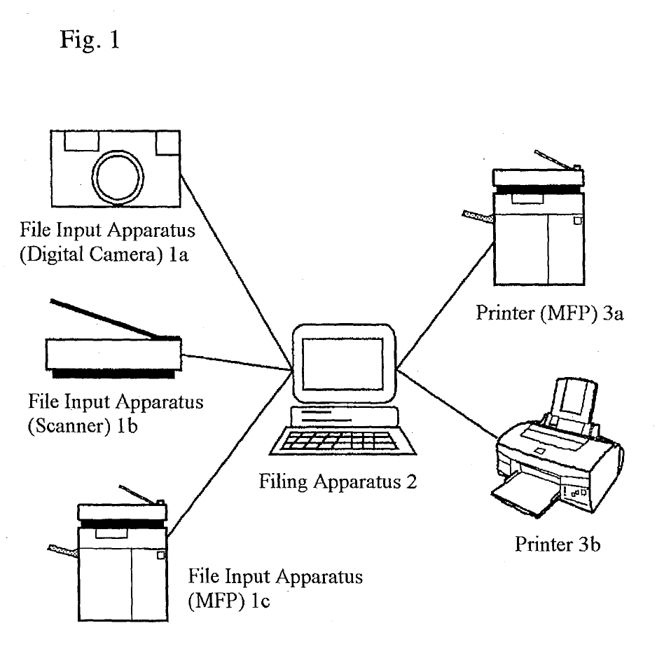

FIG. 1 is a drawing showing a specific example of the construction of a filing system (hereinafter referred to as a ‘system’) of an embodiment of the present invention.

With reference to FIG. 1, the system includes file input apparatuses 1 such as a digital camera, a scanner and an MFP (multi-function peripheral), a filing apparatus 2 such as a personal computer (hereinafter termed a ‘PC’) that is connected to the file input apparatuses 1 and can communicate therewith, and printing apparatuses 3 such as a printer and an MFP that can print data received from the filing apparatus 2. This embodiment will be described using a situation in which a digital camera, a scanner and an MFP are used as the file input apparatuses 1a, 1b and 1c, respectively, a PC is used as the filing apparatus 2, and an MFP and a printer are used as the printing apparatuses 3a and 3b, respectively, but the file input apparatuses 1, filing apparatus 2 and printing apparatuses 3 are not limited to these implementations.

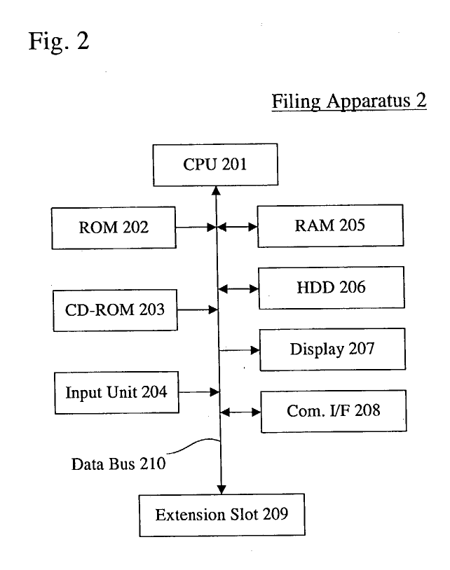

FIG. 2 is a block diagram showing the construction of the filing apparatus 2 shown in FIG. 1. With reference to FIG. 2, the filing apparatus 2 includes a CPU (central processing unit) 201 that performs overall control thereof, a system BIOS (basic input/output system) that is connected to the CPU 201 via a data bus 210 and is needed to boot the apparatus, a ROM 202 in which programs such as the initial program loader are stored, a RAM 205 that temporarily stores data and programs, an input unit 204 that forwards and controls the input from the keyboard, mouse, etc., a display unit 207 that carries out display of images, characters, letters or the like on the display, a CD-ROM device control circuit 203 that controls the CD-ROM device, a hard disk drive (HDD) 206 that includes a control circuit that controls the HDD and the hard disk, a communication I/F (interface) 208 that controls the connection between the file input apparatuses 1 and the printing apparatuses 3, and an extension slot 209 by which to connect peripheral devices.

The construction of the filing apparatus 2 shown in FIG. 2 is the common construction of a PC, but is not limited to this implementation.

The filing operations executed by the system shown in FIG. 1 will now be described.

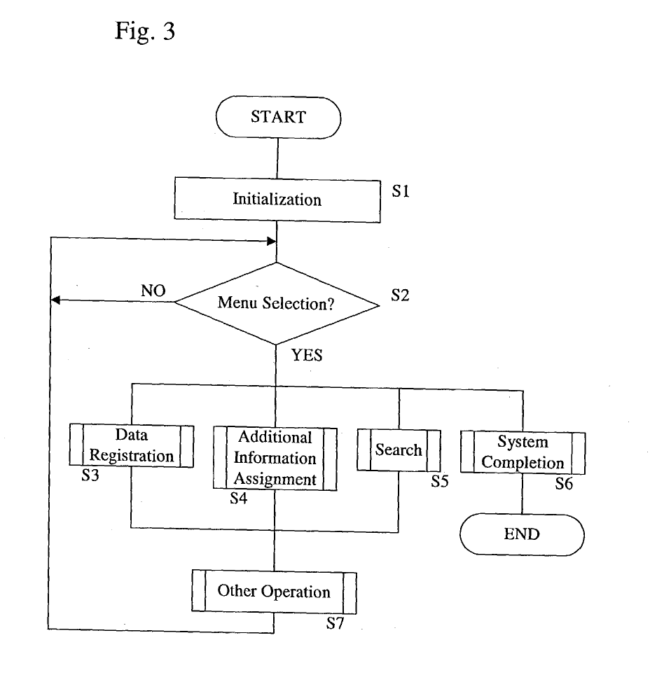

FIG. 3 is a flow chart showing the main routine of the application software program executed by the filing apparatus 2. The program, which is shown in the form of a flow chart in FIG. 3, is stored on the hard disk drive 206 of the filing apparatus 2, and is realized when read into the RAM 205 and executed by the CPU 201.

With reference to FIG. 3, when the program is booted, initialization of flags, etc. necessary in the subsequent steps and other types of processing to display the initial screen or the like are first carried out (S1).

Menu item selection is then received from the user (S2). Step S2 is repeated until a menu item is selected by the user.

Where menu item selection is received from the user in step S2 (Yes in S2), data registration (S3), additional information assignment (S4), search (S5), or system completion (S6) is executed in accordance with the menu item selected. In other words, where data registration is selected in step S2, data is received in step S3 from the file input apparatus 1, which may be any of the filing input apparatuses 1a, 1b or 1c, and is registered in the RAM 205 of the filing apparatus 2. Where additional information assignment is selected in step S2, multiple items of additional information such as keywords or markers are assigned in step S4 to a file stored in the RAM 205 of the filing apparatus 2. Where search is selected in step S2, file search is performed in step S5 using the keywords or markers assigned to the files. The search operation of step S5 will be described in detail below with reference to a subroutine. Where system completion is selected in step S2, post-processing is carried out in step S6, and this program is ended.

The received data referred to above should be stored temporarily in the RAM 205 and then in the hard disk when the post-processing is performed. Alternatively, it may be stored in the hard disk right from the start.

After the operations of step S3-S5 are performed, other operations including post-processing are executed (S7), and the CPU 201 returns to step S2 to receive menu item selection from the user.

These operations described above comprise the program executed by the filing apparatus 2 of this system.

Because the initialization of step S1, menu item selection of step S2, data registration of step S3, additional information assignment of step S4, system completion of step S6 and other operations of step S7 are operations that are executed by common PCs, they are not described in detail in connection with this embodiment.

The search operation of step S5 in FIG. 3 will now be described with reference to a subroutine.

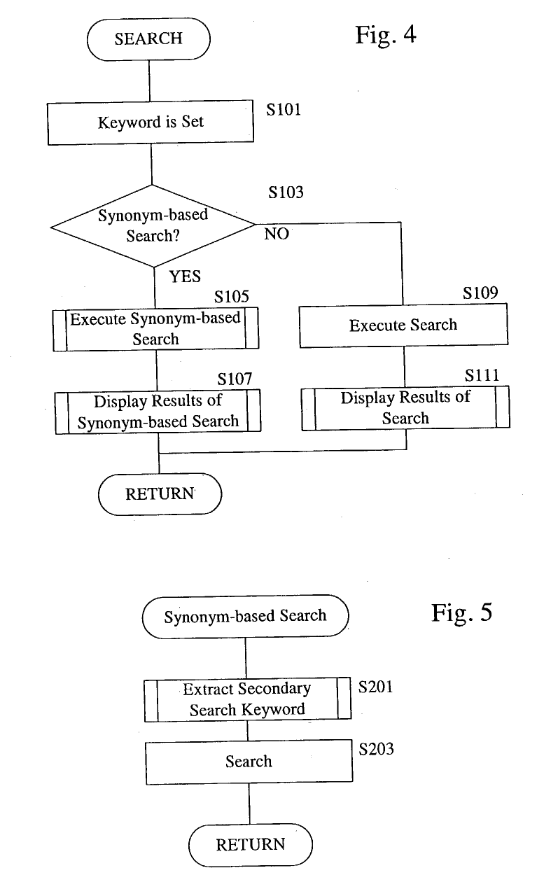

FIG. 4 is a flow chart showing the subroutine for the search operation of step S5 in FIG. 3. The program shown in the flow chart of FIG. 4 is also stored on the hard disk drive 206 of the filing apparatus 2, and is realized when read into the RAM 205 and executed by the CPU 201. While the search subroutine shown in FIG. 4 will be explained with reference to a situation wherein a search is performed using only the keywords assigned to files in step S4 in FIG. 3, the same routine naturally applies to situations in which search is carried out using information other than keywords, i.e., using markers or combinations of keywords and markers, for example.

With reference to FIG. 4, primary search keywords (first keywords), which are used for the primary search session, are first received from the user via the input unit 204 and are set as such (S101). Subsequently, selection as to whether or not to perform a secondary search, i.e., a search using synonyms, is received from the user via the input unit 204 (S103).

When selection to perform a synonym-based search is received from the user in step S103 (YES in S103), such search is executed (S105). The results of the synonym-based search obtained in step S105 are then displayed on the display unit 207 (S107). The synonym-based search operation, which is executed in step S105, and the display operation executed in step S107 are described below in detail with reference to subroutines.

When selection not to perform a synonym-based search is received from the user in step S103 (No in S103), a search is executed using the keywords set in step S101 (S109), and the results of the search are displayed on the display unit 207 (S111).

The search subroutine shown in FIG. 4 is ended after the above steps are completed, and the CPU 201 thereupon returns to the main routine shown in FIG. 3.

The synonym-based search operation, which is carried out in step S105 in FIG. 4, will now be explained below in detail with reference to a subroutine.

FIG. 5 is a flow chart showing the subroutine for the search operation of step S105 in FIG. 4. The program shown in the flow chart in FIG. 5 is also stored in the ROM 202 of the filing apparatus 2, and is realized through execution by the CPU 201.

With reference to FIG. 5, in the search routine of step S105 in FIG. 4, a search is first executed using the primary search keywords set in step S101 in FIG. 4, and secondary search keywords are extracted from among the keywords assigned to the files found as a result of the search (S201). Another search (secondary search) is performed using the keywords extracted in step S201 (S203).

The subroutine for the synonym-based search operation shown in FIG. 5 is ended when the above steps are completed, and the CPU 201 returns to the subroutine shown in FIG. 4.

The operation of step S201 in FIG. 5 to extract secondary search keywords will be described below with reference to three subroutines.

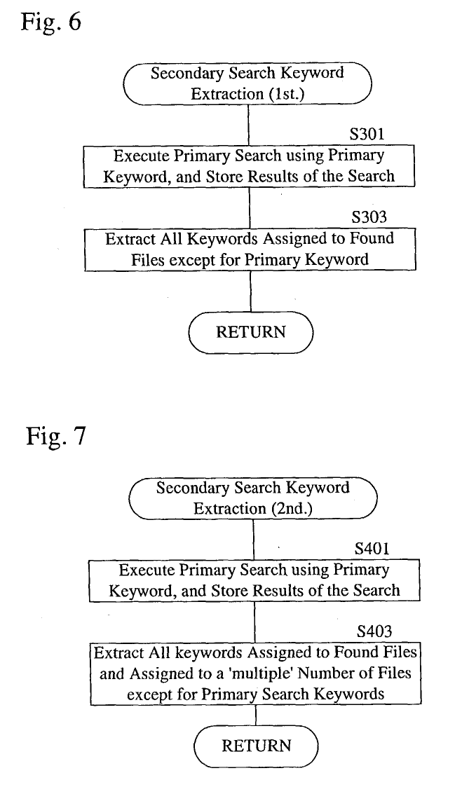

FIG. 6 is a flow chart showing a first subroutine for the secondary search keyword extraction operation of step S201 in FIG. 5.

With reference to FIG. 6, a primary search is first executed using the primary search keywords set in step S101 in FIG. 4, and the results of the search are temporarily stored for later use (S301).

All keywords other than the keyword used for the primary search are extracted from among the keywords assigned to the files found as a result of the search executed in step S301 (S303).

The subroutine shown in FIG. 6 is ended when the above steps are completed, and the CPU 201 thereafter returns to the subroutine shown in FIG. 5. In the case described above, a secondary search is executed in step S203 in FIG. 5 using all keywords other than the primary search keywords.

FIG. 7 is a flow chart showing a second subroutine for the secondary search keyword extraction operation of step S201 in FIG. 5.

With reference to FIG. 7, a primary search is first executed as in step S301 in FIG. 6, and the results of the search are temporarily stored (S401).

All keywords are extracted from among the keywords assigned to a ‘multiple’ number of files obtained in step S401 that are not the primary search keywords (S403). The number of files comprising the ‘multiple’ number of files described above may be designated by the user such that keywords assigned to two or more files or keywords assigned to three or more files will be extracted, for example, or it may consist a preset fixed number.

The subroutine shown in FIG. 7 is ended when the above steps are completed, and the CPU 201 thereafter returns to the subroutine shown in FIG. 5. In step S203 in FIG. 5, in the situation described above, a secondary search is executed using all keywords that were assigned to the multiple number of files but were not the primary search keywords.

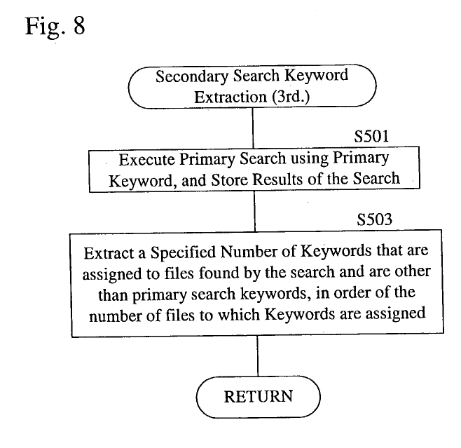

FIG. 8 is a flow chart showing a third subroutine for the secondary search keyword extraction operation of step S201 in FIG. 5.

With reference to FIG. 8, a primary search is first executed as in step S301 in FIG. 6, and the results of the search are temporarily stored (S501).

A specified number of keywords are then extracted from among the keywords that are assigned to the files found as a result of the search in step S501 and are not the primary search keywords, in the order of the number of files to which they are assigned (S503). In other words, the degree of importance of a keyword is determined based on the number of files to which it is assigned, i.e., in the order of, for example, keywords assigned to ten files, keywords assigned to eight files, keywords assigned to five files and so forth, and keywords are extracted until the specified number is reached or down to a specified rank. The number of keywords thus specified may be a preset fixed number or a user-specified number. Alternatively, a ratio in terms of files to which a keyword is assigned may be used to specify the number of keywords to be extracted. In other words, keywords assigned to 10% of the files found as a result of the primary search, for example, may be the specified setting.

The subroutine shown in FIG. 8 is ended when the above steps are completed, and the CPU 201 then returns to the subroutine shown in FIG. 5. When this subroutine is executed, a secondary search is executed using the specified number of keywords extracted in the order of the number of files to which they are assigned from among the keywords that are not the primary search keywords and are assigned to a multiple number of files.

The results of the secondary search executed using the secondary search keywords extracted via the first, second or third secondary search keyword extraction subroutine described above are then displayed in step S107 in FIG. 4. At least one of the first, second and third secondary search keyword extraction subroutines should be incorporated in the application program. Alternatively, two or three such subroutines may be incorporated therein such that the subroutine to be used is determined based on a user command or the state of processing.

The method by which to display the search results will be described below with reference to two subroutines.

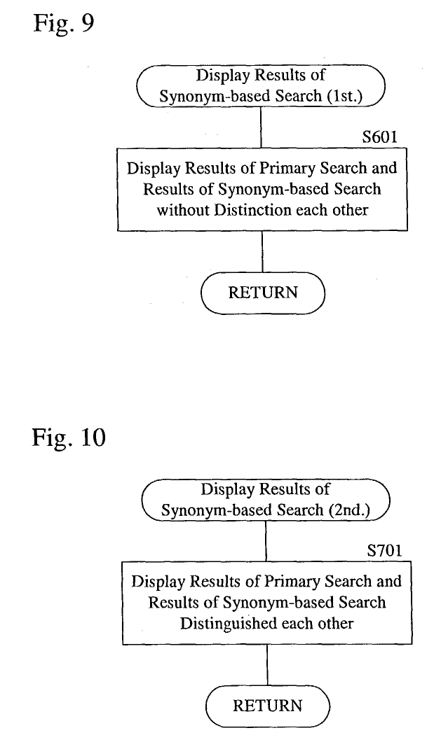

FIG. 9 is a flow chart showing a first subroutine used to display the results of the synonym-based search of step S107 in FIG. 4.

With reference to FIG. 9, in the first subroutine used to display synonym-based search results, the results of the primary search and the results of the secondary search are displayed without distinguishing one from the other (S601).

FIG. 10 is a flow chart showing a second subroutine used to display the results of the synonym-based search of step S107 in FIG. 4.

With reference to FIG. 10, in the second subroutine used to display the synonym-based search results, the results of the primary search and the results of the secondary search are displayed such that they are distinguished from each other (S701). The method for such distinction in step S701 may employ different font sizes, colors, degrees of darkness or display locations, for example, but is not limited to these implementations. The results of the secondary search using the secondary search keywords extracted via the third secondary search keyword extraction subroutine may be displayed in accordance with the degree of importance of each file, which is determined based on the importance of the secondary search keywords that are assigned to each file, such importance being determined based on the number of files to which the secondary search keywords are assigned.

The filing system described above can perform a wide-range search through the execution of the above operations. Specifically, because keywords other than the primary search keywords are extracted from the results of the search using the user-specified keywords (i.e., the primary search keywords) and another search is executed using these keywords as secondary search keywords, a wide-range search can be performed. In addition, because a secondary search is carried out using keywords that are actually assigned to files, searches for files related to the desired files can be efficiently conducted.

Because secondary search keywords are automatically extracted in this way in the filing system described above, a system that employs a thesaurus or similar reference material, which is required for the setting or maintenance of secondary search keywords in the conventional art, is no longer necessary. In addition, if the thesaurus or other reference material employed in the conventional art is used in addition to the above filing system, an even more wide-range search can be conducted.

The method by which the search results described above are sought and displayed will now be explained in detail using specific examples.

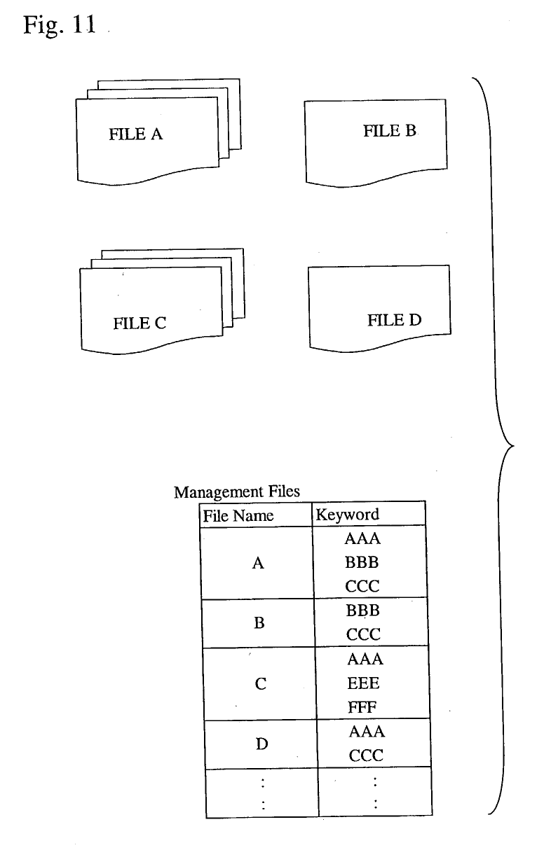

FIG. 11 is a drawing showing a specific example of files stored on the HDD 206 of the filing apparatus 2.

With reference to FIG. 11, files A-D comprising files input from the file input apparatuses 1, as well as management files therefor, are stored on the HDD 206 of the filing apparatus 2.

The files A-D shown in FIG. 11 are data files input from the file input apparatuses 1a-1c comprising such devices as a digital camera, a scanner and an MFP, and the format of each such file depends on the file input apparatus 1a-1c from which it is input in step S3 in FIG. 3.

The management files are used to manage the files A-D, and consist of files in which additional information such as keywords assigned to the files A-D in step S4 in FIG. 3 are recorded.

In connection with this embodiment, FIG. 11 shows a specific example in which the management files are stored in the filing apparatus 2 separate from the data files input from the file input apparatuses 1, but management information may be added to and stored together with each data file.

Desired files are sought in the filing system of this embodiment from the above files shown in FIG. 11.

Where ‘AAA’ is set as the primary search keyword in step S101 and a synonym-based search is selected in step S103 in FIG. 4, files including ‘AAA’ as a keyword are sought in the steps S301, S401 or S501 of FIGS. 6, 7 or 8. The files A, C and D are extracted as a result of the primary search from among the files shown in FIG. 11.

A secondary search using the keywords extracted via the first, second or third secondary search keyword extraction subroutine (termed the ‘first, second or third secondary search’ below) is then performed.

In the first secondary search shown in FIG. 6, all keywords that are not ‘AAA’, which was used in the primary search, are extracted as the secondary search keywords from among the keywords that are assigned to the files A, C and D, i.e., ‘BBB’, ‘CCC’, ‘EEE’ and ‘FFF’, and a secondary search is executed using these keywords. Therefore, as a result of the first secondary search, the files A, B, C, and D are extracted from among the files shown in FIG. 11.

In the second secondary search shown in FIG. 7, the keyword ‘CCC, which is not the ‘AAA’ keyword used in the primary search and is assigned to a multiple number of files, is extracted as the secondary search keyword from among the keywords assigned to the files A, C or D, i.e., ‘AAA’, ‘BBB’, ‘CCC’, ‘EEE’ and ‘FFF’, and a secondary search is executed using this keyword. Consequently, as a result of the second secondary search, the files A and D are extracted from among the files shown in FIG. 11. This specific example is described assuming a situation in which the number ‘two or more’ is designated as the ‘multiple’ number.

In the third secondary search shown in FIG. 8, keywords other than the ‘AAA’ keyword, which was used for the primary search, are extracted as the secondary search keywords in the order of the number of files to which they are assigned from among the keywords ‘AAA’, ‘BBB’, ‘CCC’, ‘EEE’ and ‘FFF’ assigned to the files A, C and D, and a secondary search is executed using these keywords. Where the advance setting is such that the single most common keyword is to be extracted, ‘CCC’ is extracted as the secondary search keyword, and the files A and D are extracted as a result of the third secondary search from among the files shown in FIG. 11.

When the first secondary search described above is performed, the files A, C and D including the keyword ‘AAA’ are extracted as a result of the primary search, and the file B is further extracted via the secondary search as a file related to the extracted files A, C and D. Consequently, a wide-range search can be executed based not only on the keywords set by the user, but also on keywords related to the original keywords.

When the second secondary search described above is performed, the files A, C and D that include the keyword ‘AAA’ are extracted as a result of the primary search, and the primary search results can be narrowed down to the files A and D via the secondary search using the keywords common to the files A, C and D extracted as a result of the primary search.

When the third secondary search described above is performed, the primary search results can be narrowed down to the files A and D via the secondary search using the keywords common to the files A, C and D extracted as a result of the primary search, such keywords being extracted in the order of the number of files to which they are assigned. Therefore, a more precise search can be executed based on the user-specified keywords.

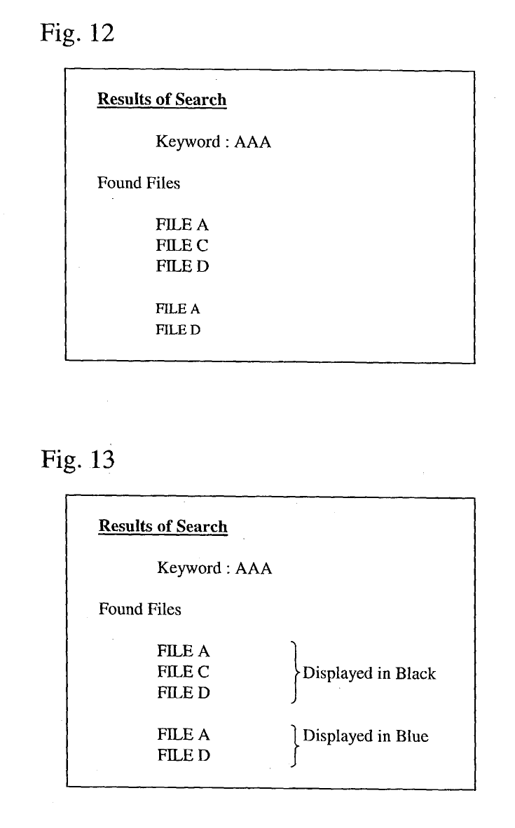

These search results undergo the first or second synonym-based search result display operation shown in FIG. 9 or FIG. 10, and are displayed on the display unit 207. FIGS. 12-15 show specific examples of the display screen used in the second synonym-based search result display subroutine. In the second synonym-based search result display subroutine, the primary search results and the secondary search results are displayed such that they are distinguished from each other.

FIG. 12 is a drawing showing a specific example of the display screen in which the primary search results and the secondary search results are displayed distinguished from each other based on a difference in font size. FIG. 12 shows an example in which the results displayed using a larger font constitute the primary search results, and the results displayed using a smaller font constitute the secondary search results. The results to be shown using a larger font or a smaller font, as well as the font sizes, may be preset or set via user command.

FIG. 13 is a drawing showing a specific example of the display screen in which the primary search results and the secondary search results are displayed distinguished from each other based on a difference in color. FIG. 13 shows an example in which the primary search results are displayed in black while the secondary search results are displayed in blue. The display colors may be preset or set via user command.

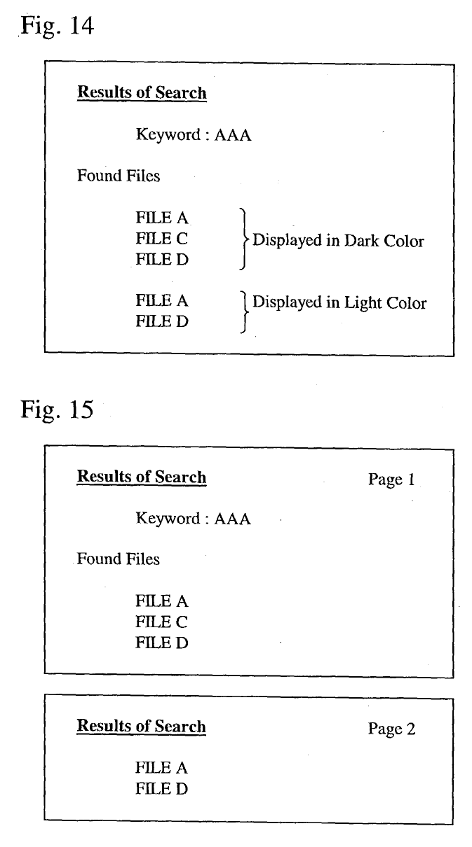

FIG. 14 is a drawing showing a specific example of the display screen in which the primary search results and the secondary search results are displayed distinguished based on a difference in the degree of darkness. FIG. 14 shows an example in which the primary search results are displayed in a darker fashion while the secondary search results are displayed in a lighter fashion. The results should be shown in a darker or lighter fashion may be preset or set via user command.

FIG. 15 is a drawing showing a specific example of the display screen in which the primary search results and the secondary search results are distinguished based on different display locations. FIG. 15 shows an example in which the primary and secondary search results are distinguished from each other based on the page on which they are displayed. The primary search results are displayed on the first page while the secondary search results are shown on the second page. Where the primary and secondary search results are to be distinguished from each other based on different display locations, they may be separated based on the display page, or based on indenting or some other method. The display location for each type of search result may be preset or set via user command.

As described above, where the primary search results and the secondary search results are displayed distinguished from each other via the second synonym-based search result display subroutine, the files directly obtained based on the original keywords and the results obtained via the synonym-based search can be displayed distinguished from each other, allowing efficient viewing of the search results.

The search method performed by the filing system described above may be provided as a program. Such a program is a computer-readable program.

The program can be provided as a program product comprising a recording medium readable by the computer or by a peripheral apparatus, such as a flexible disk, CD-ROM, ROM or memory card on which the program is recorded. Alternatively, the program may be provided stored on a recording medium such as a hard disk included in the computer, or via downloading over a network.

The program product thus provided is installed on a program storage unit such as a hard disk, for example, for execution.

The program product includes the program itself and the recording medium on which it is recorded.

The embodiments disclosed herein are examples in all aspects and should be considered as not limited in any respect. The scope of the present invention is indicated not by the above description but by the claims, and it is intended that the present invention includes meanings incorporated within the claims and all changes and modifications within the scope of the claims.

What is claimed is:

1. A computer-readable recording medium on which is stored a file search program that causes the computer to execute a file search in a file search apparatus, said program causing the computer to execute the steps of:
assigning multiple keywords to each data file;
selecting at least one keyword as a first keyword from among the keywords assigned;
searching for one or more data files using the selected first keyword or keywords;
selecting a second keyword that is assigned to the data files extracted via said search and is not said first keyword or keywords; and
searching for one or more data files using the selected second keywords.

2. The computer-readable recording medium on which is stored the file search program according to claim 1,
wherein said program further includes a display step of displaying search results from said two search sessions simultaneously in a manner that distinguishes the results from each other, and wherein in said display step, the search results from said two search sessions are displayed distinguished from each other by at least one of different character size, different character color, different character darkness and different display location.

3. The computer-readable recording medium on which is stored the file search program according to claim 1,
wherein in said second selection, keywords assigned to multiple data files are selected from among the keywords that are assigned to the data files extracted in said first searching and are not said first keyword or keywords.

4. The computer-readable recording medium on which is stored the file search program according to claim 1,
wherein in said second selection, keywords are selected in order of the number of data files to which the keywords are assigned from among the keywords that are assigned to the data files extracted in said first searching and are not said first keyword or keywords.

5. The computer-readable recording medium on which is stored the file search program according to claim 1,
wherein said data files are image data files.

6. A computer-readable recording medium on which is stored a file search program that causes the computer to execute a file search in a file search apparatus storing multiple image data files, said program causing the computer to execute the steps of:
selecting from among multiple keywords at least one keyword as the first keyword to be used to search among the image data files to which the multiple keywords are assigned;
searching for at least one image data file among the image data files using the selected first keyword or keywords;
selecting second keywords from among keywords assigned to the image data files extracted in the previous search, and the second keywords are different from the first keyword; and
searching for at least one image data file among the image data files using the selected second keywords to the extract image data files.

7. A file search apparatus comprising:
a storage device in which are stored multiple image data files, each having multiple keywords assigned thereto;
a first selector that selects as first keyword at least one keyword from among the multiple keywords;
a first searcher that performs a search among the image data files using the selected first keyword;
a second selector that selects second keywords from among the keywords assigned to the image data files extracted via said search, and the second keywords are different from the first keyword; and
a second searcher that performs a search among the image data files using the selected second keywords and extracts image data files.

8. A file search method that performs image data file search from multiple image data files, the method comprising steps of:
selecting from among multiple keywords at least one keyword as the first keyword to be used to search among the image data files to which the multiple keywords are assigned;
searching for at least one image data file among the image data files using the selected first keyword or keywords;
selecting second keywords from among keywords assigned to the image data files extracted in the previous search, and the second keywords are different from the first keyword; and
searching for at least one image data file among the image data files using the selected second keywords to the extract image data files.
